(19) United States
(12) Patent Application Publication
(10) Pub. No.: US 2026/0012002 A1
(43) Pub. Date: Jan. 8, 2026

(54) POWER SUPPLY DEVICE, METHOD FOR CONTROLLING THE SAME, AND VEHICLE POWER CONTROL SYSTEM

(71) Applicant: HL MANDO CORPORATION, Gyeonggi-do (KR)

(72) Inventors: Su Min LEE, Gyeonggi-do (KR); Sang Cheol LEE, Gyeonggi-do (KR)

(21) Appl. No.: 19/057,956

(22) Filed: Feb. 19, 2025

(30) Foreign Application Priority Data
Jul. 4, 2024 (KR) 10-2024-0087958

(51) Int. Cl. H02H 7/12; B60R 16/033; H02J 7/00; H02M 1/44

(52) U.S. Cl. CPC H02H 7/1203; B60R 16/033; H02J 7/00304; H02J 7/0063; H02M 1/44; B60Y 2400/307

(57) ABSTRACT

A power supply device, a method for controlling the same, and a vehicle power control system may prevent damage to electronic components as a reverse voltage preventer cuts off overcurrent flowing in a reverse direction when a reverse voltage is generated as a wire connecting a sensor is shorted.

### CROSS-REFERENCE TO RELATED APPLICATION

This application claims priority from Korean Patent Application No. 10-2024-0087958, filed on Jul. 4, 2024, which is hereby incorporated by reference for all purposes as if fully set forth herein.

### BACKGROUND

### Field

The present embodiments relates to a power supply device, a method for controlling the same, and a vehicle power control system, for cutting off overcurrent flowing in a reverse direction when a reverse voltage is generated as a wire connecting a sensor is shorted.

### Description of Related Art

A vehicle's power supply device is a power system for operating electronic components within the vehicle, and generally supplies 12V direct current voltage to operate the electronic components.

In recent years, however, power systems that supply 48V direct current voltage are becoming popular to increase energy capacity and enhance power efficiency.

Accordingly, application of a power system supplying 48V DC voltage requires replacement of all conventional 12V DC-operated vehicle electronic components with 48V electronic components and, if not properly controlled, the circuitry in the system may be damaged.

Accordingly, it is necessary to configure a voltage limiting circuit to meet the maximum allowable voltage of 48V.

However, configuring a voltage limiting circuit to meet the maximum allowable voltage may lead to an increase in size and resultantly deteriorate space utilization while increasing costs.

In particular, if a reverse voltage is generated due to the short circuit of the wire connecting the sensor, overcurrent may flow in the reverse direction, damaging electronic components.

Further, if a reverse voltage preventing circuit is configured to address such issues, the supplied voltage increases, causing leakage current, with the result of increasing power consumption.

### SUMMARY

The present embodiments may provide a power supply device, a method for controlling the same, and a vehicle power control system, for cutting off overcurrent flowing in a reverse direction when a reverse voltage is generated as a wire connecting a sensor is shorted.

In an aspect, the present embodiments may provide a power supply device, comprising a first power converter configured to frequency-convert a first voltage, output from a power source, to a second voltage lower than the first voltage, a second power converter configured to frequency-convert the second voltage, output from the first power converter, to a third voltage lower than the second voltage, and, in response to a fourth voltage boosted from the third voltage, output a fifth voltage lower than the fourth voltage to a controller, and a sixth voltage lower than the fourth voltage to a sensor, the controller configured to receive the fifth voltage output from the second power converter, and a reverse voltage preventer having at least one switch and configured to cut off an overcurrent toward the second power converter based on the second voltage and a reverse voltage caused by short of a wire connecting the second power converter and the sensor.

In another aspect, the present embodiments may provide a power supply control method, comprising by a first power converter, frequency-converting a first voltage output from a power source, to a second voltage lower than the first voltage, by a second power converter, frequency-converting the second voltage' output from the first power converter, to a third voltage lower than the second voltage, and, in response to a fourth voltage boosted from the third voltage, outputting a fifth voltage lower than the fourth voltage to a controller, and outputting a sixth voltage lower than the fourth voltage to a sensor, by the controller, receiving the fifth voltage output from the second power converter, and by a reverse voltage preventer having at least one switch, cutting off an overcurrent toward the second power converter based on the second voltage and a reverse voltage caused by short of a wire connecting the second power converter and the sensor.

In another aspect, the present embodiments may provide a vehicle power control system, comprising a power source configured to provide a direct current DC voltage, a sensor unit including a torque sensor and an angle sensor, and a power supply device configured to cut off an overcurrent in a reverse direction if a reverse voltage caused by short of a wire connecting the sensor unit is generated.

The present embodiments may provide a power supply device, a method for controlling the same, and a vehicle power control system, which may prevent damage to electronic components as a reverse voltage preventer cuts off overcurrent flowing in a reverse direction when a reverse voltage is generated as a wire connecting a sensor is shorted.

The present embodiments may provide a power supply device, a method for controlling the same, and a vehicle power control system, which may reduce power consumption by optimizing leak current by driving a first switch driver based on the voltage of input power without using a separate dedicated IC.

### BRIEF DESCRIPTION OF THE DRAWINGS

The above and other objects, features, and advantages of the disclosure will be more clearly understood from the following detailed description, taken in conjunction with the accompanying drawings, in which:

FIG. 1 is a block diagram schematically illustrating a vehicle having a power supply device according to the present embodiments;

FIG. 2 is a block diagram illustrating a power supply device according to the present embodiments;

FIG. 3 is a circuit diagram illustrating a power supply device according to an embodiment;

FIG. 4 is a circuit diagram illustrating a power supply device according to another embodiment; and

FIG. 5 is a flowchart illustrating a power supply control method according to the present embodiments.

### DETAILED DESCRIPTION

In the following description of examples or embodiments of the disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the disclosure, detailed descriptions of well-known functions and components incorporated herein will be omitted when it is determined that the description may make the subject matter in some embodiments of the disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B) ” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

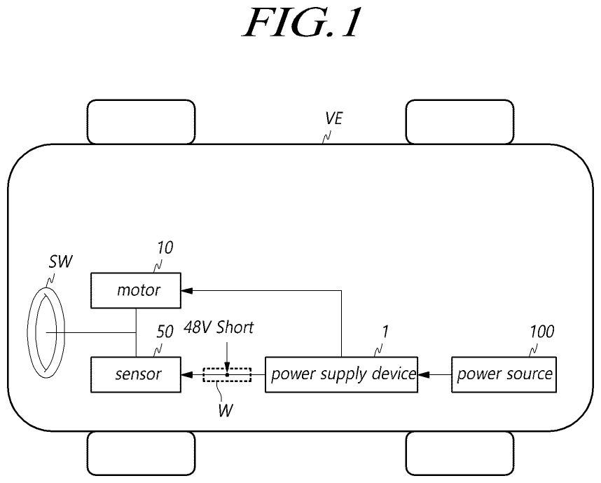

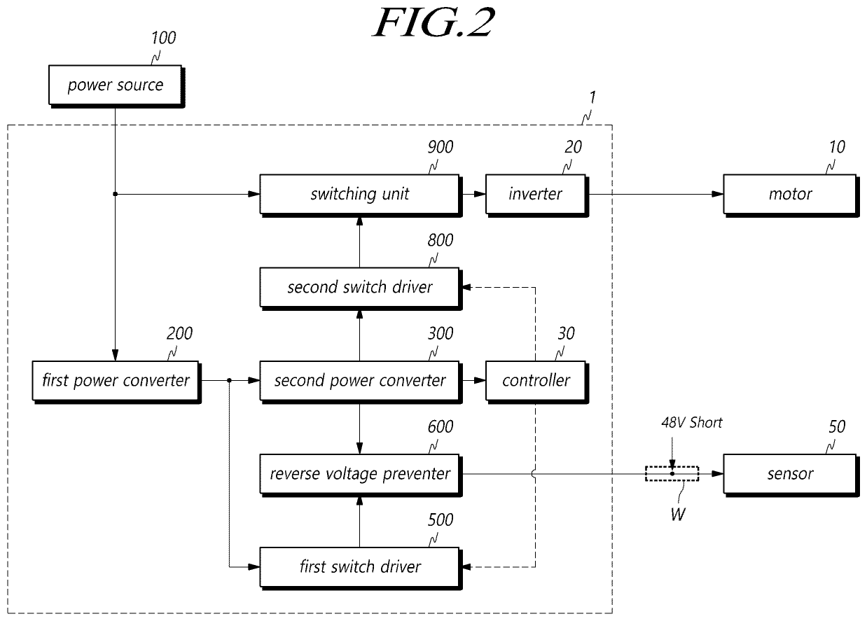

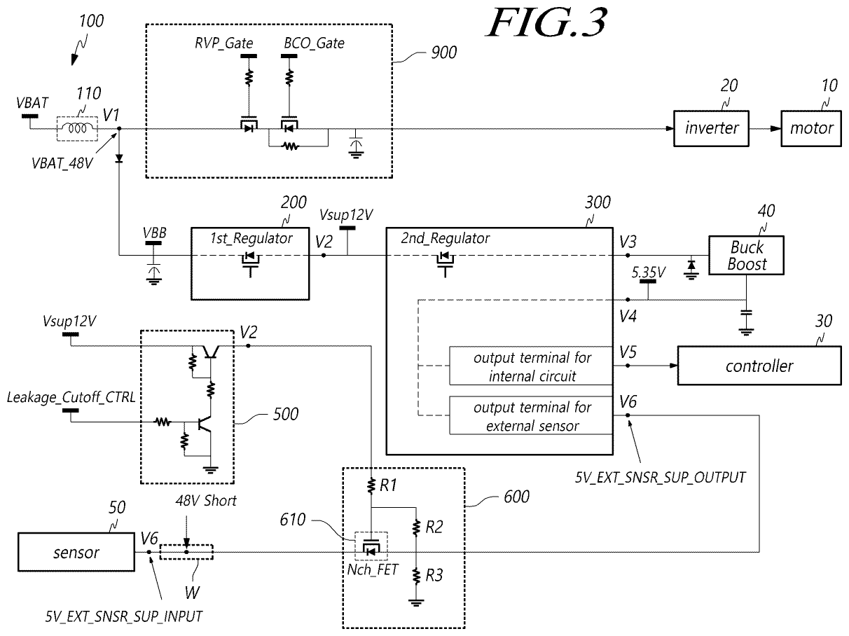

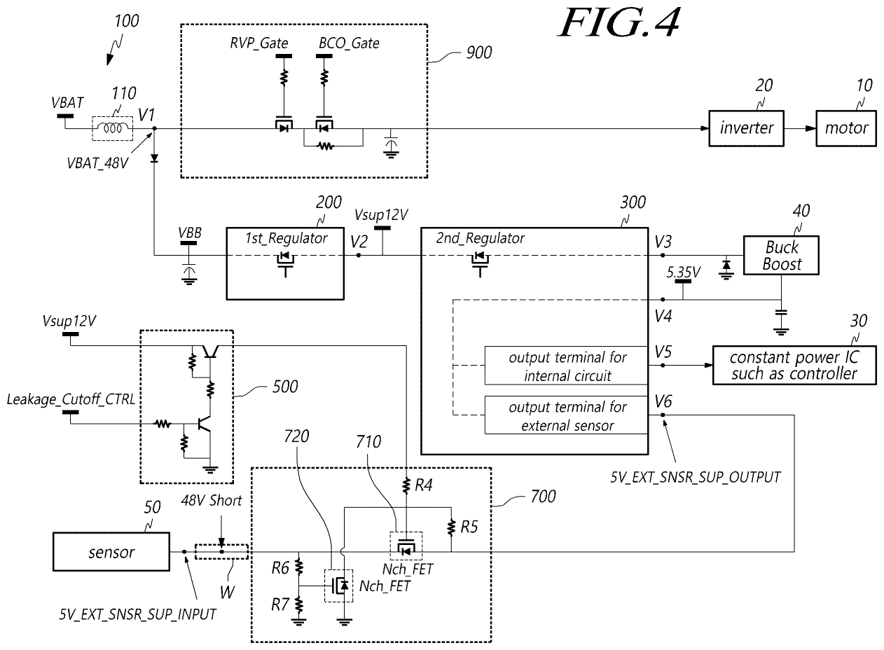

FIG. 1 is a block diagram schematically illustrating a vehicle having a power supply device according to the present embodiments. FIG. 2 is a block diagram illustrating a power supply device according to the present embodiments. FIG. 3 is a circuit diagram illustrating a power supply device according to an embodiment. FIG. 4 is a circuit diagram illustrating a power supply device according to another embodiment.

A vehicle power control system according to the present embodiments may include a power source 100, a sensor 50, and a power supply device 1. The sensor 50 may include the external sensor.

Referring to FIG. 1, a vehicle VE may include a power source 100 configured to provide a direct current (DC) voltage, a sensor unit 50 including a torque sensor and an angle sensor, and a power supply device 1 configured to cut off an overcurrent in a reverse direction if a reverse voltage caused by short of a wire W connecting the sensor unit 50 is generated.

The power source 100 may include a power source of at least one of a direct current (DC) voltage and an alternating current (AC) voltage.

The sensor 50 may include a torque sensor measuring a twisting force applied to a rotating component such as the steering wheel SW of the vehicle and an angle sensor measuring the position or rotating angle of the rotating component such as the steering wheel SW.

Referring to FIGS. 2 to 4, the power supply device 1 may include a first power converter 200, a second power converter 300, a first switch driver 500, a reverse voltage preventer 600, a second switch driver 800, and a switching unit 900.

In an aspect, a power supply device 1 according to the present embodiments may include a first power converter 200 configured to frequency-convert a first voltage V1, output from a power source 100, to a second voltage V2 lower than the first voltage V1, a second power converter 300 configured to frequency-convert the second voltage V2, output from the first power converter 200, to a third voltage V3 lower than the second voltage V2, and, in response to a fourth voltage V4 boosted from the third voltage V3 output a fifth voltage V5 lower than the fourth voltage to a controller, and a sixth voltage V6 lower than the fourth voltage V4 to a sensor, a controller 30 configured to receive the fifth voltage V5 output from the second power converter 300, a reverse voltage preventer 600 having at least one switch and configured to cut off an overcurrent toward the second power converter 300 based on the second voltage V2 and a reverse voltage caused by short of a wire W connecting the second power converter 300 and the sensor 50, and a first switch driver 500 connected between the first power converter 200 and the reverse voltage preventer 600 and configured to output the second voltage V2 output from the first power converter 200 according to a control signal of the controller 30.

The power source 100 may include a power source of at least one of direct current (DC) voltage and alternating current (AC) voltage, and may supply the first voltage V1 to the first power converter 200 and the switching unit 900.

Here, the first voltage V1 may be a DC voltage, and the DC voltage may be battery power.

In this case, the first voltage V1 is not limited thereto, and may include any power source that may supply DC voltage.

For example, the power source 100 may generate and output a 48V DC voltage as the first voltage V1 in the battery.

A filter 110 may receive the battery voltage of the power source 100 and filter the battery voltage to output the filtered first voltage V1.

Here, the filter 110 may include reactors, capacitors, and the like.

The first power converter 200 may receive and modulate the first voltage V1 output from the power source 100, and convert the frequency to generate and output a second voltage V2 lower than the first voltage V1.

The first power converter 200 may be connected to the power source 100 and may receive a first voltage V1 output from the power source 100.

In this case, the first power converter 200 may receive a DC voltage from the power source 100.

The first power converter 200 may modulate the first voltage V1 supplied from the power source 100 and convert the frequency to generate a second voltage V2 lower than the first voltage V1.

More specifically, the first power converter 200 may modulate the DC voltage, which is the first voltage V1 supplied from the power source 100, into a pulse wave, and convert the frequency to generate and output the second voltage V2 lower than the first voltage V1.

Here, the pulse wave may include a positive pulse wave.

The first power converter 200 may include a DC-DC converter. For example, the first power converter 200 may include a buck converter and a boost converter, but is not limited thereto, and may include any converter that may drop the received DC voltage into a DC voltage lower than the received DC voltage.

The first power converter 200 according to the present embodiments may include a buck converter that modulates the first voltage V1 output as a DC voltage into a positive pulse wave and converts into the second voltage V2 lower than the first voltage V1 through a switching-type regulator.

In other words, the buck converter may modulate the DC voltage supplied from the power source 100 to a positive pulse wave through the switching-type regulator, and convert the frequency to generate and output the second voltage V2 lower than the first voltage V1.

For example, the first power converter 200 may modulate the 48V DC voltage, which is the first voltage V1 supplied from the power source 100, into a pulse wave, convert the frequency, and generate and output a 12V DC voltage, as the second voltage V2, lower than the first voltage V1.

In this case, the first power converter 200 may be configured to generate and output the second voltage V2 within a preset voltage range, and may be configured to generate and output a DC voltage of 20 V or less as the second voltage V2. The preset voltage range may be set as a voltage range larger than 10V and smaller than 18V.

The second power converter 300 may receive the second voltage V2 output from the first power converter 200 and convert the frequency to output a third voltage V3 lower than the second voltage V2 and receive a fourth voltage V4 boosted from the third voltage V3 to generate and output a fifth voltage V5 and a sixth voltage V6 lower than the fourth voltage V4.

The second power converter 300 may be connected to the first power converter 200 and may receive the second voltage V2 output from the first power converter 200.

In this case, the second power converter 300 may receive the second voltage V2 modulated into a positive pulse wave from the first power converter 200.

The second power converter 300 may convert the frequency of the second voltage V2 supplied from the first power converter 200 to generate a third voltage V3 lower than the second voltage V2.

Further, the second power converter 300 may receive the fourth voltage V4 boosted from the third voltage V3 to generate the fifth voltage V5 and the sixth voltage V6 lower than the fourth voltage V4.

In this case, the second power converter 300 may convert the frequency of the second voltage V2 supplied from the first power converter 200 to generate the fifth voltage V5 and the sixth voltage V6 lower than the second voltage V2.

The second power converter 300 may include a DC-DC converter. For example, the second power converter 300 may include a buck converter and a boost converter, but is not limited thereto, and may include any converter that may drop the received DC voltage into a DC voltage lower than the received DC voltage or boost the decreased DC voltage into a higher DC voltage.

The second power converter 300 according to the present embodiments may include a buck converter converting the second voltage V2 output as a DC voltage to a third voltage V3 lower than the second voltage V2 through a switching-type regulator.

Further, the present embodiments may further include a boost converter configured to convert the third voltage V3 output as a DC voltage to a fourth voltage V4 lower than the second voltage V2 and higher than the third voltage V3 through a switching-type regulator.

In other words, the buck converter may convert the frequency of the second voltage V2 modulated into a positive pulse wave in the first power converter 200 and generate and output the third voltage V3 lower than the second voltage V2.

The boost converter 40 may generate and output the fourth voltage V4 lower than the second voltage V2 and higher than the third voltage V3 using the generated third voltage V3.

For example, the second power converter 300 may drop the 12V DC voltage, which is the second voltage V2 supplied from the first power converter 200, and generate and output a 5V or 3.3V DC voltage lower than the second voltage V2 as the third voltage V3.

The boost converter 40 may boost the DC voltage of 5V or 3.3V, which is the generated third voltage V3, and generate and output the DC voltage of 5.35V, which is lower than the second voltage V2 and higher than the third voltage V3, as the fourth voltage V4.

The second power converter 300 may receive the fourth voltage V4 boosted from the third voltage V3 to generate and output a DC voltage of 5V or 3.3V lower than the 5.35V direct voltage which is the fourth voltage V4, as the fifth voltage V5, and receive the fourth voltage V4 boosted from the third voltage V3 to generate and output a DC voltage of 5V lower than the 5.35V direct voltage which is the fourth voltage V4, as the sixth voltage V6.

In this case, the second power converter 300 may drop the 12V DC voltage which is the second voltage V2 received from the first power converter 200 and generate and output the 5V or 3.3V DC voltage lower than the second voltage V2 as the fifth voltage V5, and drop the 12 DC voltage which is the second voltage V2 received from the first power converter 200 and generate and output the 5V DC voltage lower than the second voltage V2 as the sixth voltage V6.

The controller 30 may receive the fifth voltage V5 output from the second power converter 300 to operate.

The controller 30 may be connected to the second power converter 300 and may receive the fifth voltage V5 output from the second power converter 300 to operate.

For example, the controller 30 may receive a DC voltage of 5V or 3.3V, which is the fifth voltage V5 generated by the second power converter 300, to operate.

Here, the controller 30 may be connected to the power source 100, the first power converter 200, the second power converter 300, the first switch driver 500, and the second switch driver 800 to control and monitor their operations.

Further, the power supply device 1 according to the present embodiments may further include a first switch driver 500 connected between the first power converter 200 and the reverse voltage preventer 600 to output the second voltage V2 output from the first power converter 200 according to a control signal of the controller 30.

The first switch driver 500 may be connected between the first power converter 200 and the reverse voltage preventer 600, and may output the second voltage V2 output from the first power converter 200 according to a control signal of the controller 30.

When the first switch driver 500 is turned on according to the control signal of the controller 30, the first switch driver 500 may output the second voltage V2.

In this case, when the second voltage V2 output from the first switch driver 500 is supplied to the gate of the first switch element 610 so that the first switch element 610 is turned on, the reverse voltage preventer 600 may output the sixth voltage V6 to the sensor 50 by forming a voltage (or current) path between the second power converter 300 and the sensor 50.

Meanwhile, when the first switch driver 500 is turned off according to the control signal of the controller 30, the first switch driver 500 may not output the second voltage V2.

In this case, when the first switch element 610 is turned off because the second voltage V2 output from the first switch driver 500 is not supplied to the gate of the first switch element 610, the reverse voltage preventer 600 may not output the sixth voltage V6 to the sensor 50 because a voltage (or current) path is not formed between the second power converter 300 and the sensor 50.

The power supply device 1 according to the present embodiments may reduce power consumption by minimizing leakage current by driving the first switch driver 500 based on the voltage of the input power without using a separate dedicated IC.

Subsequently, the reverse voltage preventer 600 may cut off an overcurrent toward the second power converter 300 based on the second voltage V2 and a reverse voltage caused by a short of a wire W connecting the second power converter 300 and the sensor 50.

The reverse voltage preventer 600, according to an embodiment shown in FIG. 3, may include a first switch element 610, which is configured to be turned on if the second voltage V2 output from the first switch driver 500 is equal to or greater than a preset reference voltage, thereby supplying the sixth voltage V6 output from the second power converter 300 to the sensor 50, and to be turned off if the reverse voltage caused by the short of the wire W connecting the second power converter 300 and the sensor 50 is generated, thereby cutting off overcurrent toward the second power converter 300.

In this case, the first switch element 610 may include a field effect transistor (FET) configured to be turned on if the second voltage V2 output from the first switch driver 500 is supplied to a gate of the FET, and to be turned off if the 48V reverse voltage caused by the short of the wire W connecting the second power converter 300 and the sensor 50 is generated.

In other words, the first switch element 610 may include an N-channel field effect transistor (FET) having a gate connected to the first switch driver 500, a source connected to the second power converter 300, and a drain connected to the sensor 50.

Further, the reverse voltage preventer 600 may include a first resistor R1 connected between the first switch driver 500 and the gate of the first switch element 610, a second resistor R2 connected between the gate of the first switch element 610 and the source of the first switch element 610, and a third resistor R3 connected between the source of the first switch element 610 and the ground.

Here, the reverse voltage preventer 600 may be configured so that the ratio of the sum of the resistance of the first resistor R1 and the resistance of the second resistor R2 to the resistance of the third resistor R3 is about 7:3 to apply 5V to both the ends of the third resistor R3 in a state in which the second voltage V2 output from the first switch driver 500 is supplied to the gate of the first switch element and the sixth voltage V6 output from the second power converter 300 is not supplied to the sensor.

For example, the resistance of the first resistance R1 may be 3K(106 ), the resistance of the second resistance R2 may be 39K(106 ), and the resistance of the third resistance R3 may be 30K(106 ) so that the ratio of the sum of the resistance of the first resistance R1 and the resistance of the second resistor R2 to the resistance of the third resistance R3 is 7:3.

Accordingly, if the second voltage V2 output from the first switch driver 500 is supplied to the gate, the first switch element 610 may maintain the turned-on state, and may output the sixth voltage V6 of the second power converter 300 to the sensor 50 without FET body diode forward voltage drop.

On the other hand, the first switch element 610 may be unable to maintain the VGS voltage due to a reverse voltage caused by a short of a wire W connecting the second power converter 300 and the sensor 50, resulting in a turn-off state and cutting off an overcurrent toward the second power converter 300.

As such, the power supply device 1 according to an embodiment may prevent damage to electronic components by cutting off the overcurrent flowing in the reverse direction by the reverse voltage preventer 600.

The reverse voltage preventer 700, according to another embodiment shown in FIG. 4, may include a first switch element 710, which is configured to be turned on if the second voltage V2 output from the first switch driver 500 is equal to or greater than a preset reference voltage, thereby supplying the sixth voltage V6 output from the second power converter 300 to the sensor 50, and to be turned off if the reverse voltage caused by the short of the wire W connecting the second power converter 300 and the sensor 50 is generated, is turned off by the second switch element 720 to cut off overcurrent toward the second power converter 300.

Additionally, the reverse voltage preventer 700 may include a second switch element 720 configured to be turned on to turn off the first switch element 710 when the reverse voltage caused by the short of the wire W connecting the second power converter 300 and the sensor 50 is generated.

In this case, the first switch element 710 may include a field effect transistor (FET) that is turned on when the second voltage V2 output from the first switch driver 500 is supplied to the gate, and turned off by the second switch element 720 when the wire W connecting the second power converter 300 and the sensor 50 is shorted and a reverse voltage is generated.

In other words, the first switch element 710 may include an N-channel field effect transistor (FET) having a gate connected to the first switch driver 500, a source connected to the second power converter 300, and a drain connected to the sensor 50.

Further, the second switch element 720 may include a field effect transistor (FET) configured to be turned on if the reverse voltage caused by the short of the wire W connecting the second power converter 300 and the sensor 50 is generated so that a voltage of a gate of the FET is to be equal to or greater than a preset reference voltage.

In other words, the second switch element 720 may include an N-channel field effect transistor (FET) having a gate connected to a drain of the first switch element 710, a source connected to the ground, and a drain connected to the gate of the first switch element 710.

Further, the reverse voltage preventer 700 may include a fourth resistor R4 connected between the first switch driver 500 and the gate of the first switch element 710, a fifth resistor R5 connected between the gate of the first switch element 710 and a source of the first switch element 710, a sixth resistor R6 connected between the drain of the first switch element 710 and a gate of the second switch element 720, and a seventh resistor R7 connected between the gate of the second switch element 720 and the ground.

Here, the reverse voltage preventer 700 may be configured so that a ratio of a sum of a resistance of the fourth resistor R4 and the resistance of the fifth resistor R5 to a sum of a resistance of the sixth resistor R6 and the resistance of the seventh resistor R7 is around 7:5 in a state in which the second voltage V2 output from the first switch driver 500 is supplied to the gate of the first switch element and the sixth voltage V6 output from the second power converter 300 is not supplied to the sensor.

For example, the resistance of the fourth resistance R4 may be 300(106 ), the resistance of the fifth resistance R5 may be 3.9K(Ω), the resistance of the sixth resistance R6 may be 2.7K(Ω), and the resistance of the seventh resistor R7 is 300(106 ), so that the ratio of the sum of the resistance of the fourth resistance R4 and the resistance of the fifth resistor R5 to the sum of the resistance of the sixth resistance R6 and the resistance of the seventh resistor R7 is 7:5.

In this case, in a state in which the second voltage V2 output from the first switch driver 500 is supplied to the gate, and the sixth voltage V6 output from the second power converter 300 is not supplied, the fourth voltage R4 and the fifth voltage R5 may have resistances at which the first switch element 710 may maintain the turned-on state, and the sixth resistor R6 and the seventh resistor R7 may have resistances at which the second switch element 720 may maintain the turned-off state.

Accordingly, if the second voltage V2 output from the first switch driver 500 is supplied to the gate, the first switch element 710 may maintain the turned-on state, and may output the sixth voltage V6 of the second power converter 300 to the sensor 50 without FET body diode forward voltage drop.

On the other hand, due to a reverse voltage caused by short of a wire W connecting the second power converter 300 and the sensor 50, the VGS voltage of the second switch element 720 increases, turning it ON, while the VGS voltage of the first switch element 710 decreases, turning it OFF, thereby cutting off an overcurrent toward the second power converter 300.

As such, the power supply device 1 according to another embodiment may prevent damage to electronic components by cutting off the overcurrent flowing in the reverse direction by the reverse voltage preventer 700.

The second switch driver 800 may be connected to the second power converter 300 and may receive the voltage output from the second power converter 300.

The switching unit 900 may be connected between the power source 100 and the inverter 20 or the motor 10, and may control the connection between the power source 100 and the inverter 20 or the motor 10 based on the voltage output from the second switch driver 800.

The switching unit 900 may include an input terminal, an output terminal, and a control terminal.

Here, the input terminal may be connected to the power source 100, the output terminal may be connected to the inverter 20 or the motor 10, and the control terminal may be connected to the second switch driver 800.

For example, as the control terminal voltage is larger than the threshold voltage, the switching unit 900 may supply the first voltage V1 output from the power source 100 to the inverter 20.

In other words, when the voltage at the gate terminal is greater than the voltage at the input terminal, the input terminal and the output terminal of the switching unit 900 may be connected to each other to supply the first voltage V1 output from the power source 100 to the inverter 20.

The inverter 20 may include any converter that may receive a DC voltage from a DC-AC converter and convert the DC voltage into an AC voltage.

The inverter 20 may be connected between the switching unit 900 and the motor 10, and may convert the voltage output and supplied from the switching unit 900 and supply the converted voltage to the motor 10.

Here, the motor 10 may be a steering motor 10 included in the steering device of the vehicle.

Accordingly, the controller 30 may detect at least one of the operation state of the inverter 20 and the operation state of the motor 10, generate a control signal according to the detection result, and output the control signal to the second switch driving unit 800.

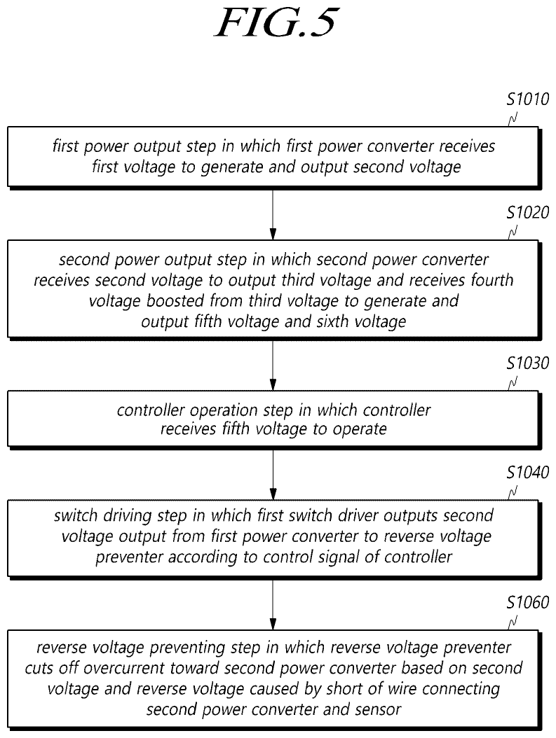

FIG. 5 is a flowchart illustrating a power supply control method according to the present embodiments.

In another aspect, a power supply control device according to the present embodiments may include a first power converter 200, frequency-converting a first voltage V1, output from a power source 100, to a second voltage V2 lower than the first voltage V1, by a second power converter 300, frequency-converting the second voltage V2 output from the first power converter 200 to a third voltage V3 lower than the second voltage V2, and in response to a fourth voltage V4 boosted from the third voltage V3, outputting a fifth voltage V5 lower than the fourth voltage to a controller, and outputting a sixth voltage V6 lower than the fourth voltage V4 to a sensor, by a controller 30, receiving the fifth voltage V5 output from the second power converter 300, by a first switch driver 500, outputting the second voltage V2 output from the first power converter 200 according to a control signal of the controller 30, and by a reverse voltage preventer 600 having at least one switch, cutting off an overcurrent toward the second power converter 300 based on the second voltage V2 a reverse voltage caused by short of a wire W connecting the second power converter and the sensor 50. In other words, a power supply control device according to the present embodiments may include a first power output step S1010, by a first power converter 200, frequency-converting a first voltage V1 output from a power source 100 to a second voltage V2 lower than the first voltage V1, a second power output step S1020, by a second power converter 300, frequency-converting the second voltage V2 output from the first power converter 200 to a third voltage V3 lower than the second voltage V2, and in response to a fourth voltage V4 boosted from the third voltage V3, outputting a fifth voltage V5 lower than the fourth voltage to a controller, and outputting a sixth voltage V6 lower than the fourth voltage V4 to a sensor, a controller operation step S1030, by a controller 30, receiving the fifth voltage V5 output from the second power converter 300, a switching driving step S1040, by a first switch driver 500, outputting the second voltage V2 output from the first power converter 200 according to a control signal of the controller 30, and a reverse voltage preventing step S1060, by a reverse voltage preventer 600 having at least one switch, cutting off an overcurrent toward the second power converter 300 based on the second voltage V2 a reverse voltage caused by short of a wire W connecting the second power converter and the sensor 50.

Referring to FIG. 5, in the first power output step S1010, the first power converter 200 may receive and modulate the first voltage V1 output from the power source 100, and generate and output a second voltage V2 lower than the first voltage V1.

In the second power output step S1020, the second power converter 300 may receive and convert the second voltage V2 output from the first power converter 200 to output the third voltage V3 lower than the second voltage V2.

Further, the second power output step S1020 may receive the fourth voltage V4 boosted from the third voltage V3 to generate and output the fifth voltage V5 and the sixth voltage V6 lower than the fourth voltage V4.

In the controller operation step S1030, the controller 30 may receive the fifth voltage V5 output from the second power converter 300 to operate.

In the switching driving step S1040, the first switch driver 500 may output the second voltage V2 output from the first power converter 200 to the reverse voltage preventer 600 according to a control signal of the controller 30.

In this case, the sensor 50 may receive the sixth voltage V6 output from the second power converter 300 to operate.

In the reverse voltage preventing step S1060, The reverse voltage preventer 600 may cut off an overcurrent toward the second power converter 300 based on the second voltage V2 and a reverse voltage caused by a short of a wire W connecting the second power converter 300 and the sensor 50.

According to an embodiment, in the reverse voltage preventing step S1060, if the second voltage V2 output from the first switch driver 500 is equal to or greater than a preset reference voltage, turning on a first switch element 610 included in the at least one switch of the reverse voltage preventer 600 to supply the sixth voltage V6 output from the second power converter 300 to the sensor 50, and, if the reverse voltage caused by the short of the wire W connecting the second power converter 300 and the sensor 50 is generated, turning off the first switch element 610 included in the at least one switch of the reverse voltage preventer 600 to cut off overcurrent toward the second power converter 300.

In this case, the first switch element 610 may include a field effect transistor (FET) if the second voltage V2 output from the first switch driver 500 is supplied to the gate of the FET, be turned on, and if the 48V reverse voltage caused by the short of the wire W connecting the second power converter 300 and the sensor 50 is generated, be turned off.

In other words, the first switch element 610 may include an N-channel field effect transistor (FET) having a gate connected to the first switch driver 500, a source connected to the second power converter 300, and a drain connected to the sensor 50.

Here, the reverse voltage preventer 600 may include a first resistor R1 connected between the first switch driver 500 and the gate of the first switch element 610, a second resistor R2 connected between the gate of the first switch element 610 and the source of the first switch element 610, and a third resistor R3 connected between the source of the first switch element 610 and the ground.

The reverse voltage preventer 600 may be configured so that the ratio of the sum of the resistance of the first resistor R1 and the resistance of the second resistor R2 to the resistance of the third resistor R3 is about 7:3 to apply 5V to both the ends of the third resistor R3 in a state in which the second voltage V2 output from the first switch driver 500 is supplied to the gate of the first switch element and the sixth voltage V6 output from the second power converter 300 is not supplied to the sensor.

For example, the resistance of the first resistance R1 may be 3K(Ω), the resistance of the second resistance R2 may be 39K(Ω), and the resistance of the third resistance R3 may be 30K(Ω) so that the ratio of the sum of the resistance of the first resistance R1 and the resistance of the second resistor R2 to the resistance of the third resistance R3 is 7:3.

Accordingly, if the second voltage V2 output from the first switch driver 500 is supplied to the gate, the first switch element 610 may maintain the turned-on state, and may output the sixth voltage V6 of the second power converter 300 to the sensor 50 without FET body diode forward voltage drop.

On the other hand, the first switch element 610 may be unable to maintain the VGS voltage due to a reverse voltage caused by a short of a wire W connecting the second power converter 300 and the sensor 50, resulting in a turn-off state and cutting off an overcurrent toward the second power converter 300.

As such, the power supply device 1 according to an embodiment may prevent damage to electronic components by cutting off the overcurrent flowing in the reverse direction by the reverse voltage preventer 600.

According to another embodiment, in the reverse voltage preventing step S1060, if the second voltage V2 output from the first switch driver 500 is a preset reference voltage or more, the first switch element 710 of the reverse voltage preventer 700 may be turned on to supply the sixth voltage V6 output from the second power converter 300 to the sensor 50.

Here, the cutting off the overcurrent comprises turning on a second switch element 720 of the reverse voltage preventer to turn off the first switch element 710 if the reverse voltage caused by the short of the wire W connecting the second power converter 300 and the sensor 50 is generated.

In other words, in the reverse voltage preventing step S1060, turning on a second switch element 720 of the reverse voltage preventer to turn off the first switch element 710 if the reverse voltage caused by the short of the wire W connecting the second power converter 300 and the sensor 50 is generated.

Accordingly, in the reverse voltage preventing step S1060, the first switch element 710 may be turned off by the second switch element 720, cutting off overcurrent toward the second power converter 300.

In this case, the first switch element 710 may include a field effect transistor (FET) that is turned on when the second voltage V2 output from the first switch driver 500 is supplied to the gate, and turned off by the second switch element 720 when the wire W connecting the second power converter 300 and the sensor 50 is shorted and a reverse voltage is generated.

In other words, the first switch element 710 may include an N-channel field effect transistor (FET) having a gate connected to the first switch driver 500, a source connected to the second power converter 300, and a drain connected to the sensor 50.

Further, the second switch element 720 may include a field effect transistor (FET) configured to be turned on if the reverse voltage caused by the short of the wire W connecting the second power converter 300 and the sensor 50 is generated so that a voltage of a gate voltage.

In other words, the second switch element 720 may include an N-channel field effect transistor (FET) having a gate connected to the first switch element 710, a source connected to the ground, and a drain end connected to the gate of the first switch element 710.

Here, the reverse voltage preventer 700 may include a fourth resistor R4 connected between the first switch driver 500 and the gate of the first switch element 710, a fifth resistor R5 connected between the gate of the first switch element 710 and the source of the first switch element 710, a sixth resistor R6 connected between the drain of the first switch element 710 and the gate of the second switch element 720, and a seventh resistor R7 connected between the gate of the second switch element 720 and the ground.

The reverse voltage preventer 700 may be configured so that the ratio of the sum of the resistance of the fourth resistor R4 and the resistance of the fifth resistor R5 to the sum of the resistance of the sixth resistor R6 and the resistance of the seventh resistor R7 is around 7:5 in a state in which the second voltage V2 output from the first switch driver 500 is supplied to the gate of the first switch element and the sixth voltage V6 output from the second power converter 300 is not supplied to the sensor.

For example, the resistance of the fourth resistance R4 may be 300(106 ), the resistance of the fifth resistance R5 may be 3.9K(Ω), the resistance of the sixth resistance R6 may be 2.7K(106 ), and the resistance of the seventh resistor R7 is 300(106 ), so that the ratio of the sum of the resistance of the fourth resistance R4 and the resistance of the fifth resistor R5 to the sum of the resistance of the sixth resistance R6 and the resistance of the seventh resistor R7 is 7:5.

In this case, in a state in which the second voltage V2 output from the first switch driver 500 is supplied to the gate, and the sixth voltage V6 output from the second power converter 300 is not supplied, the fourth voltage R4 and the fifth voltage R5 may have resistances at which the first switch element 710 may maintain the turned-on state, and the sixth resistor R6 and the seventh resistor R7 may have resistances at which the second switch element 720 may maintain the turned-off state.

Accordingly, if the second voltage V2 output from the first switch driver 500 is supplied to the gate, the first switch element 710 may maintain the turned-on state, and may output the sixth voltage V6 of the second power converter 300 to the sensor 50 without FET body diode forward voltage drop.

On the other hand, if the wire W connecting the second power converter 300 and the sensor 50 is shorted to generate a reverse voltage, the second switch element 720 may be turned on as the VGS voltage increases, and the first switch element 710 may be turned off as the VGS voltage decreases, cutting off overcurrent toward the second power converter 300.

As such, the power supply control method may prevent damage to electronic components by cutting off the overcurrent flowing in the reverse direction by the reverse voltage preventer 700.

The above description has been presented to enable any person skilled in the art to make and use the technical idea of the disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the disclosure. The above description and the accompanying drawings provide an example of the technical idea of the disclosure for illustrative purposes only. That is, the disclosed embodiments are intended to illustrate the scope of the technical idea of the disclosure. Thus, the scope of the disclosure is not limited to the embodiments shown, but is to be accorded the widest scope consistent with the claims. The scope of protection of the disclosure should be construed based on the following claims, and all technical ideas within the scope of equivalents thereof should be construed as being included within the scope of the disclosure.

What is claimed is:

1. A power supply device comprising:
a first power converter configured to frequency-convert a first voltage, output from a power source, to a second voltage lower than the first voltage;
a second power converter configured to frequency-convert the second voltage, output from the first power converter, to a third voltage lower than the second voltage, and, in response to a fourth voltage boosted from the third voltage, output a fifth voltage lower than the fourth voltage to a controller, and a sixth voltage lower than the fourth voltage to a sensor;
the controller configured to receive the fifth voltage output from the second power converter; and
a reverse voltage preventer having at least one switch and configured to cut off an overcurrent toward the second power converter based on the second voltage and a reverse voltage caused by short of a wire connecting the second power converter and the sensor.

2. The power supply device of claim 1, further comprising a first switch driver connected between the first power converter and the reverse voltage preventer and configured to output the second voltage output from the first power converter according to a control signal of the controller.

3. The power supply device of claim 2, wherein the at least one switch of the reverse voltage preventer includes a first switch element configured to:
if the second voltage output from the first switch driver is equal to or greater than a preset reference voltage, be turned on to supply the sixth voltage output from the second power converter to the sensor, and
if the reverse voltage caused by the short of the wire connecting the second power converter and the sensor is generated, be turned off to cut off the overcurrent toward the second power converter.

4. The power supply device of claim 3, wherein the first switch element has a field effect transistor (FET) configured to:
if the second voltage output from the first switch driver is supplied to a gate of the FET, be turned on, and
if the reverse voltage caused by the short of the wire connecting the second power converter and the sensor is generated, be turned off.

5. The power supply device of claim 3, wherein the reverse voltage preventer includes:
a first resistor connected between the first switch driver and a gate of the first switch element;
a second resistor connected between the gate of the first switch element and a source of the first switch element; and
a third resistor connected between the source of the first switch element and a ground.

6. The power supply device of claim 5, wherein the reverse voltage preventer is configured so that a ratio of a sum of a resistance of the first resistor and a resistance of the second resistor to a resistance of the third resistor is about 7:3 in a state in which the second voltage output from the first switch driver is supplied to the gate of the first switch element and the sixth voltage output from the second power converter is not supplied to the sensor.

7. The power supply device of claim 3, wherein the reverse voltage preventer includes a second switch element configured to be turned on to turn off the first switch element when the reverse voltage caused by the short of the wire connecting the second power converter and the sensor is generated.

8. The power supply device of claim 7, wherein the second switch element has a field effect transistor (FET) configured to be turned on if the reverse voltage caused by the short of the wire connecting the second power converter and the sensor is generated so that a voltage of a gate of the FET is to be equal to or greater than a preset reference voltage.

9. The power supply device of claim 8, wherein the second switch element has a gate connected to a drain of the first switch element, a source connected to a ground, and a drain connected to a gate of the first switch element.

10. The power supply device of claim 7, wherein the reverse voltage preventer includes:
a fourth resistor connected between the first switch driver and a gate of the first switch element;
a fifth resistor connected between the gate of the first switch element and a source of the first switch element;
a sixth resistor connected between a drain of the first switch element and a gate of the second switch element; and
a seventh resistor connected between the gate of the second switch element and a ground.

11. The power supply device of claim 10, wherein the reverse voltage preventer is configured so that a ratio of a sum of a resistance of the fourth resistor and a resistance of the fifth resistor to a sum of a resistance of the sixth resistor and a resistance of the seventh resistor is around 7:5 in a state in which the second voltage output from the first switch driver is supplied to the gate of the first switch element and the sixth voltage output from the second power converter is not supplied to the sensor.

12. The power supply device of claim 1, further comprising a boost converter configured to convert the third voltage of the second power converter into a voltage lower than the second voltage and higher than the third voltage.

13. A power supply control method comprising:
by a first power converter, frequency-converting a first voltage, output from a power source, to a second voltage lower than the first voltage;
by a second power converter, frequency-converting the second voltage, output from the first power converter, to a third voltage lower than the second voltage, and, in response to a fourth voltage boosted from the third voltage, outputting a fifth voltage lower than the fourth voltage to a controller, and outputting a sixth voltage lower than the fourth voltage to a sensor;
by the controller, receiving the fifth voltage output from the second power converter; and
by a reverse voltage preventer having at least one switch, cutting off an overcurrent toward the second power converter based on the second voltage and a reverse voltage caused by short of a wire connecting the second power converter and the sensor.

14. The power supply control method of claim 13, further comprising, by a first switch driver, outputting the second voltage output from the first power converter according to a control signal of the controller.

15. The power supply control method of claim 14, wherein the cutting off the overcurrent comprises:
if the second voltage output from the first switch driver is equal to or greater than a preset reference voltage, turning on a first switch element included in the at least one switch of the reverse voltage preventer to supply the sixth voltage output from the second power converter to the sensor, and,
if the reverse voltage caused by the short of the wire connecting the second power converter and the sensor is generated, turning off the first switch element included in the at least one switch of the reverse voltage preventer to cut off the overcurrent toward the second power converter.

16. The power supply control method of claim 15, wherein the first switch element has a field effect transistor (EFT) configured to:
if the second voltage output from the first switch driver is supplied to a gate of the FET, be turned on, and
if the reverse voltage caused by the short of the wire connecting the second power converter and the sensor is generated, be turned off.

17. The power supply control method of claim 15, wherein the cutting off the overcurrent comprises turning on a second switch element of the reverse voltage preventer to turn off the first switch element if the reverse voltage caused by the short of the wire connecting the second power converter and the sensor is generated.

18. The power supply control method of claim 17, wherein the second switch element has a field effect transistor (FET) configured to be turned on if the reverse voltage caused by the short of the wire connecting the second power converter and the sensor is generated so that a voltage of a gate of the FET is equal to or greater than a preset reference voltage.

19. A vehicle power control system comprising:
a power source configured to provide a direct current (DC) voltage;
a sensor unit including a torque sensor and an angle sensor; and
a power supply device configured to cut off an overcurrent in a reverse direction if a reverse voltage caused by short of a wire connecting the sensor unit is generated.

20. The vehicle power control system of claim 19, wherein the power supply device includes:
a first power converter configured to frequency-convert a first voltage, output from a power source, to a second voltage lower than the first voltage;
a second power converter configured to frequency-convert the second voltage, output from the first power converter, to a third voltage lower than the second voltage, and, in response to a fourth voltage boosted from the third voltage, output a fifth voltage lower than the fourth voltage to a controller, and a sixth voltage lower than the fourth voltage to the sensor unit; and
a reverse voltage preventer having at least one switch and configured to cut off an overcurrent toward the second power converter based on the second voltage and a reverse voltage caused by short of the wire connecting the second power converter and the sensor unit.
